(19) United States
(12) Patent Application Publication
(10) Pub. No.: US 2016/0070356 A1
(43) Pub. Date: Mar. 10, 2016

(54) PHYSICALLY INTERACTIVE MANIFESTATION OF A VOLUMETRIC SPACE

(71) Applicant: Microsoft Corporation, Redmond, WA (US)

(72) Inventors: Nicole Aguirre, Seattle, WA (US); Richard Barraza, Kirkland, WA (US); Justine Coates, Redmond, WA (US); Marc Goodner, Kirkland, WA (US); Abram Jackson, Kirkland, WA (US); Michael Megalli, Seattle, WA (US)

(21) Appl. No.: 14/479,369

(22) Filed: Sep. 7, 2014

(51) Int. Cl. G06F 3/01

(52) U.S. Cl. CPC G06F 3/017

(57) ABSTRACT

A “PiMovs System” provides a “physically interactive manifestation of a volumetric space” (i.e., PiMovs). The perimeter of a geometric framework is wrapped with contiguous display surfaces to cover each section of the perimeter with adjacent display surfaces. Additional contiguous display surfaces may cover top and/or bottom surfaces of the framework, with some edges of those display surfaces also adjacent edges of display surfaces on the perimeter. Sensors track positions and natural user interface (NUI) inputs of users within a predetermined zone around the framework. A contiguous volumetric projection is generated and displayed over the framework via the display surfaces as a seamless wrapping across each edge of each adjacent display surface. This volumetric projection is then automatically adapted to tracked user positions and NUI inputs.

### BACKGROUND

Stereo photography uses a camera with two or more lenses (or a single camera that moves between image capture) to simulate human binocular vision in order to capture simulated 3D images. The resulting stereo images can be used with 3D glasses and the like to present a 3D view of the image to a user. In related work, volumetric displays use specialized equipment to provide users with a 3D visual representation of 3D objects or models.

In contrast, panoramic photography uses specialized equipment or software to capture images with elongated fields of view that may cover up to 360 degrees. Such panoramas may be projected on curved screens, or on multiple screens or displays, that cover the interior or walls of a room or space to allow users inside that room or space to view the panorama as if they were inside the scene of the panorama.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of prior technologies may be noted or discussed herein, the claimed subject matter is not intended to be limited to implementations that may solve or address any or all of the disadvantages of those prior technologies.

In general, a “PiMovs System,” as described herein, provides various techniques for implementing a physically interactive manifestation of a volumetric space (i.e., “PiMovs”). This interactive volumetric projection allows multiple users to view and interact with 2D and/or 3D content rendered on contiguous display surfaces covering or comprising a geometric framework.

More specifically, the PiMovs System provides an interactive volumetric display comprising a plurality of display surfaces positioned in a contiguous arrangement around the outside perimeter of a geometric framework. Further, one or more additional display surfaces may be optionally positioned to cover a top and/or bottom surface of the geometric framework. In other words, at least the outer perimeter and, optionally, the top and/or bottom surfaces of the geometric framework are covered with contiguous adjacent display surfaces. The PiMovs System uses one or more computing devices that together generate a contiguous volumetric projection on the display surfaces that is visible to users outside of the geometric framework. This volumetric projection represents a seamless wrapping of the contiguous volumetric projection that continues across each edge of each adjacent display surface.

Note also that in various implementations, this volumetric projection represents a seamless wrapping of the contiguous volumetric projection across the surface of a single curved or flexible 360-degree display covering (or forming) the perimeter of the geometric framework. Consequently, for purposes of explanation, the following discussion will sometimes use the phrase “contiguous display surface,” which is defined as referring to both cases, including multiple adjacent displays covering or comprising the geometric framework and a single curved or flexible 360-degree display covering or comprising the perimeter of the geometric framework.

To enable various interaction scenarios and capabilities, the PiMovs System uses one or more cameras or other position sensing devices or techniques to track positions of one or more people within a predetermined radius around the outside of the geometric framework. The PiMovs System then automatically adapts the contiguous volumetric projection in real-time to the tracked positions of the people around the outside of the geometric framework. This causes objects within the contiguous volumetric projection to appear to occupy a consistent position in space within the geometric framework relative to those people as they move around the outside of the geometric framework. Note also that as images or video of things or objects move or transition around the contiguous display surface, including when transitioning across any adjacent screen edges or display surfaces, that transition is also seamless.

In view of the above summary, it is clear that the PiMovs System described herein provides various techniques for implementing a physically interactive manifestation of a volumetric space using contiguous display surfaces covering the exterior of a geometric framework. In addition to the just described benefits, other advantages of the PiMovs System will become apparent from the detailed description that follows hereinafter when taken in conjunction with the accompanying drawing figures.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary illustration showing multiple users viewing a contiguous volumetric projection covering display surfaces arranged on a geometric framework of a “PiMovs System”, as described herein.

FIG. 2 illustrates an exemplary architectural flow diagram of a “PiMovs System” for implementing a physically interactive manifestation of a volumetric space using contiguous display surfaces covering the exterior of a geometric framework, as described herein.

FIG. 3 provides an exemplary architectural flow diagram that illustrates an exemplary hardware layout of the PiMovs System, showing computing, display, and natural user interface (NUI) hardware, as described herein.

FIG. 4 provides a partial internal view of a single exemplary cube-shaped PiMovs unit, where computing devices and tracking and NUI sensors have been omitted for clarity, as described herein.

FIG. 5 provides a top view of single exemplary PiMovs unit with an amorphous perimeter shape, showing exemplary computing, projection, and NUI hardware, as described herein.

FIG. 6 provides a top view of single PiMovs unit showing a fixed or adjustable interaction zone at some minimum distance around a perimeter of the PiMovs unit, as described herein.

FIG. 7 provides an illustration of an exemplary PiMovs ecosystem showing multiple users interacting with individual PiMovs units that are in communication from arbitrary locations, as described herein.

FIG. 8 provides an illustration showing multiple users interacting with an exemplary digital art application enabled by the PiMovs system, as described herein.

FIG. 9 provides an illustration showing multiple users interacting with an exemplary digital art application enabled by the PiMovs system, as described herein.

FIG. 10 provides an illustration showing a user of a local PiMovs unit attempting to contact another user of a different PiMovs unit via an exemplary communication application enabled by the PiMovs system, as described herein.

FIG. 11 provides an illustration showing a user of a local PiMovs unit communicating with a user of a remote PiMovs unit via an exemplary communication application enabled by the PiMovs system, as described herein.

FIG. 12 provides an illustration of an exemplary location selection application enabled by the PiMovs system, as described herein.

FIG. 13 illustrates a general operational flow diagram that illustrates exemplary hardware and methods for effecting various implementations of the PiMovs System, as described herein.

FIG. 14 is a general system diagram depicting a simplified general-purpose computing device having simplified computing and I/O capabilities for use in effecting various implementations of the PiMovs System, as described herein.

### DETAILED DESCRIPTION

In the following description of various implementations of the claimed subject matter, reference is made to the accompanying drawings, which form a part hereof, and in which is shown by way of illustration specific implementations in which the claimed subject matter may be practiced. It should be understood that other implementations may be utilized and structural changes may be made without departing from the scope of the presently claimed subject matter.

1.0 Introduction:

In general, a “PiMovs System,” as described herein, provides various techniques for implementing a physically interactive manifestation of a volumetric space (i.e., “PiMovs”). Note that since multiple PiMovs Systems may interact and communicate, individual PiMovs Systems will sometimes be referred to as “PiMovs units” for purposes of discussion.

In various implementations, the PiMovs System is effected by arranging a plurality of display surfaces (e.g., monitors, projective surfaces, or other display devices) to cover the outer surface of a geometric framework. The geometric framework is implemented in any desired shape, including but not limited to, pyramidal, cubic, circular, amorphous, etc., having sidewall sections and, optionally, either or both a top and bottom section, thereby forming a 360 degree geometric framework of any desired size. The perimeter of this geometric framework is wrapped with contiguous display surfaces to cover each section of the perimeter with adjacent display surfaces.

Note also that in various implementations, this volumetric projection represents a seamless wrapping of the contiguous volumetric projection across the surface of a single curved or flexible 360-degree display covering (or forming) the perimeter of the geometric framework. Consequently, for purposes of explanation, the following discussion will sometimes use the phrase “contiguous display surface,” which is defined as referring to both cases, including multiple adjacent displays covering or comprising the geometric framework and a single curved or flexible 360-degree display covering or comprising the perimeter of the geometric framework.

The PiMovs System then generates and displays a contiguous volumetric projection over the geometric framework via the contiguous display surface wrapping or comprising that framework. More specifically, the volumetric projection is contiguous in that it is rendered as a seamless wrapping across each bordering edge of each adjacent display surface, or across the continuous surface (and any seams in that may exist in that surface) of the single display covering or comprising the perimeter of the geometric framework. In other words, the contiguous volumetric projection seamlessly wraps across all adjacent edges of the sides, and optionally the top and/or the bottom, of the geometric framework. The result is a 360-degree seamless wrapping of the contiguous volumetric projection around the contiguous display surface forming sidewalls of the geometric framework that also optionally includes a seamless wrapping of that same volumetric projection from every side that crosses and covers the optional top and/or bottom of the geometric framework.

Note that this wrapping is considered seamless in that the volumetric projection continues across adjacent display edges. As such, in cases where display surfaces include edge bezels or other borders limiting projection or display capabilities, there may be corresponding visible lines or edges of those display surfaces in the otherwise contiguous volumetric projection. However, in various implementations, the PiMovs System uses either displays without bezels or frames, or uses projective display surfaces without bezels or frames, such that the adjacent edges of each display surface connect with visually seamless boundaries.

Further, sensors monitoring one or more regions on the exterior of the geometric framework are then used to track positions and natural user interface (NUI) inputs of people within a predetermined radius around the framework. Note that NUI inputs include, but are not limited to, voice inputs, gesture-based inputs, including both air and contact-based gestures or combinations thereof, user touch on various surfaces, objects or other users, hover-based inputs or actions, etc. Further, in various implementations, tracking and/or gesture-based inputs may include a mirroring of user motions or gestures such that a representation of a creature, person, digital avatar, etc., displayed on the contiguous display surface may perform movements, motions, or gestures that track and/or mirror one or more persons within the predetermined radius around the geometric framework.

In various implementations, the PiMovs System then dynamically adapts the contiguous volumetric projection in response to the tracked positions and/or one or more NUI inputs of one or more users. For example, in various implementations, this dynamic adaption provides capabilities including, but not limited to, adapting the volumetric projection to the tracked positions and/or any one or more NUI inputs. One example of such dynamic adaptation is that, in various implementations, the volumetric projection is automatically adapted in real-time in a way that makes objects within the projection appear to occupy consistent positions in space within the framework relative to tracked people as they move around the outside of the geometric framework.

Advantageously, multiple PiMovs Systems may interact via wired or wireless networks or other communications links. Such interaction may be either real-time or delayed, depending on the particular applications and/or content associated with contiguous volumetric projections on any one or more of the interacting PiMovs Systems. As a result, users interacting with any PiMovs System, anywhere, may interact with other PiMovs Systems, or other users of other PiMovs Systems. At least part of the contiguous volumetric projections displayed on any section of any one or more of those interacting PiMovs Systems may then dynamically adapt to the interaction between any combination of user NUI inputs, user tracking, and PiMovs System interactions. The resulting technical effects of such implementations include, but are not limited to, providing improved user interaction efficiency and increased user interaction performance.

Advantageously, in various implementations, these capabilities enable the PiMovs System to provide visions of seamless imagery placed in everyday environments connected by local communities across the world (and/or in orbital or other space-based locations). As a result, the PiMovs System enables a wide range of interaction and communication capabilities. For example, because the PiMovs System can be placed anywhere, in various implementations, the PiMovs System provides an interactive canvas for curation (e.g., volumetric displays of artwork, volumetric portals into 3D locations such as outdoor events, museums, the International Space Station, etc.). Advantageously, user experiences enabled by such capabilities open a bridge between new combinations of technology, art, education, entertainment, and design. The resulting technical effects of such implementations include, but are not limited to, providing improved user interaction efficiency and increased user interaction performance.

Further, the interactive experiences of each user, or of non-user viewers of the PiMovs System, may be contextually different depending upon the content of the contiguous volumetric projection and any particular user interactions or motions relative to that content. Consequently, the PiMovs System provides a public (or private) object that connects people and locations through exchanges that are educational, work-related, public or private events, entertainment, games, communication, etc. In many such exchanges, multiple users may be creating, sharing, hearing, seeing, and interacting with contiguous volumetric projections in ways that can appear to be magical local or global and experiences, or combinations of both local and global experiences. The resulting technical effects of such implementations include, but are not limited to, providing improved user interaction efficiency and increased user interaction performance.

1.1 System Overview:

As noted above, the geometric framework of the PiMovs System can be formed in any desired shape. However, for purposes of explanation, the following discussion will generally refer to a version of the geometric framework that is formed in the shape of a cube, having four sides and a top that are covered by display surfaces. Again, it should be understood that top and/or bottom display surfaces of the PiMovs System are optional.

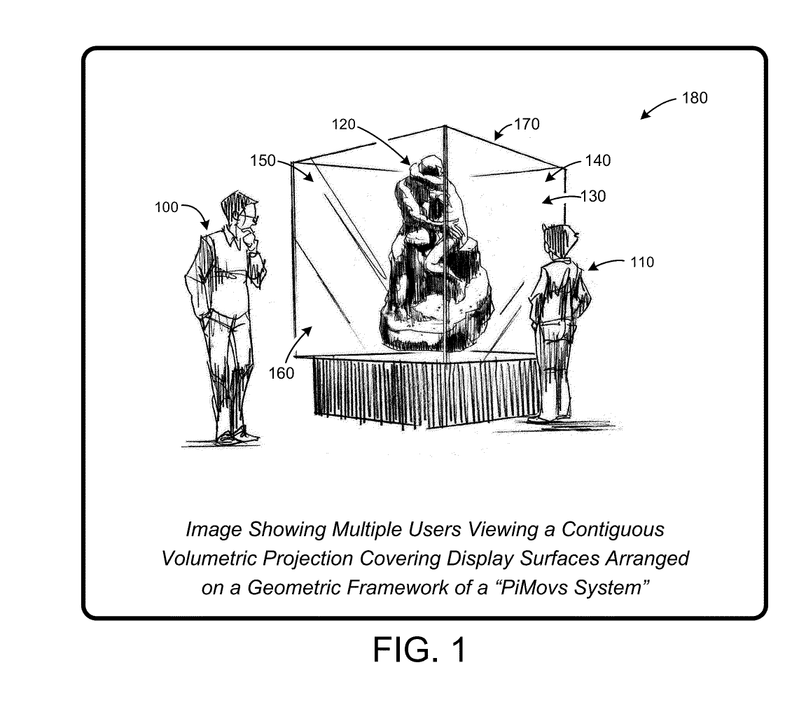

For example, a tested implementation of the PiMovs System was constructed in a cubic format, using sidewalls and a top constructed of clear acrylic panels or other translucent or transparent polymer or glass materials coated with a flexible rear-projection material to define “rear projective display panels.” Under the control of one or more computing devices, a separate projector for each of the five faces of the cube (excluding the bottom of the cube in this example) were arrayed inside of the cube to project images and/or video onto the rear-projection material covering the rear surface of each acrylic panel. However, it should be understood that single projectors may be used to cover multiple faces, or that multiple projectors may be used to cover single faces. Those projected images and/or video were then clearly visible from the exterior of the cube. Further, a variety of tracking and NUI sensors were arrayed around the cube to allow tracking and inputs to be received relative to multiple users near the cube. FIG. 1 shows an artistic rendering of the exterior of such a cube. In particular, FIG. 1 provides an exemplary illustration showing multiple users (100 and 110) viewing a contiguous volumetric projection 120 covering display surfaces (130, 140, 150, 160, and 170) forming the outer surface of a cubic PiMovs System 180.

Note that the volumetric projection 120 of FIG. 1, although rendered on the display surfaces (130, 140, 150, 160, and 170) on the exterior of the cube, appears to viewers (100 and 110) as a work of art displayed on the interior of the cube. This visual impression is maintained because each face of the cube displays the artwork from a different perspective, and because the volumetric projection completely and seamlessly wraps the entire perimeter and top of the cube in this example. Consequently, in this example the volumetric projection appears to users as a rendering of a 3D object inside of the cube, even as the users move around the exterior of the cube.

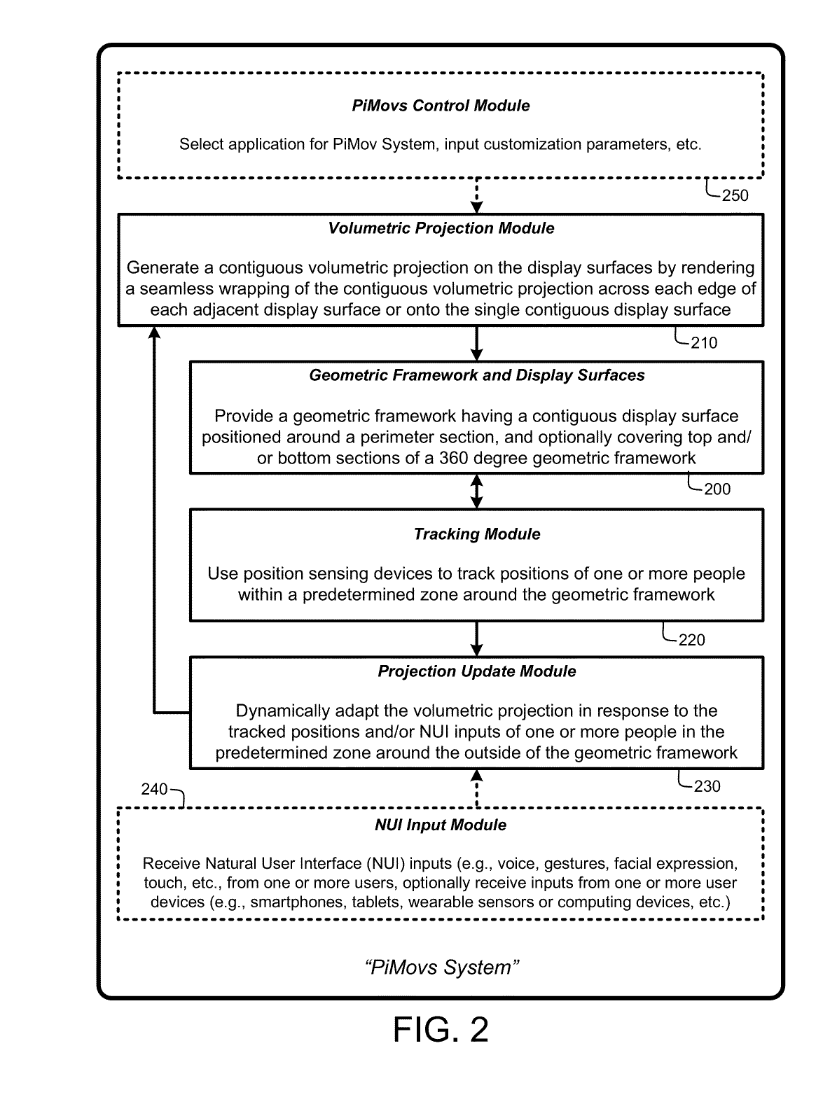

Some of the processes summarized above are illustrated by the general system diagram of FIG. 2. In particular, the system diagram of FIG. 2 illustrates the interrelationships between various hardware components and program modules for effecting various implementations of the PiMovs System, as described herein. Furthermore, while the system diagram of FIG. 2 illustrates a high-level view of various implementations of the PiMovs System, FIG. 2 is not intended to provide an exhaustive or complete illustration of every possible implementation of the PiMovs System as described throughout this document.

In addition, it should be noted that any boxes and interconnections between boxes that may be represented by broken or dashed lines in FIG. 2 represent alternate or optional implementations of the PiMovs System described herein. Further, any or all of these alternate or optional implementations, as described below, may be used in combination with other alternate implementations that are described throughout this document.

In general, as illustrated by FIG. 2, the processes enabled by the PiMovs System begin operation by providing a geometric framework 200 wrapped (or formed from) display surfaces. In general, this geometric framework 200 includes a plurality of display surfaces positioned in a contiguous arrangement around a perimeter section and top and/or bottom sections of a 360-degree geometric framework, or a single curved or flexible 360-degree display covering (or forming) the perimeter of the geometric framework. The PiMovs System then uses a volumetric projection module 210 to generate a contiguous volumetric projection on the display surfaces by rendering, displaying, and/or projecting a seamless wrapping of the contiguous volumetric projection that flows across each edge of each adjacent display surface or onto the single contiguous display surface.

A tracking module 220 uses various position sensing devices to track positions of one or more people within a predetermined radius around the geometric framework. Alternately, or in combination, an NUI input module 240 receives one or more NUI inputs (e.g., voice, gestures, facial expression, touch, etc.) and/or optionally receive inputs from one or more user devices (e.g., smartphones, tablets, wearable sensors or computing devices, etc.), from one or more users. A projection update module 230 then dynamically adapts the volumetric projection in response to the tracked positions and/or NUI inputs of one or more people in a predetermined zone around the outside of the geometric framework of the PiMovs System.

Finally, a PiMovs control module 250 provides an administrative user interface or the like that is used to select one or more applications and/or user interface modes to be displayed or used to interact with the PiMovs System, and/or to input customization parameters, etc. Interaction with the PiMovs control module 250 is accomplished using any of a variety of communications techniques, including, but not limited to wired or wireless communications systems that allows administrative users to remotely access the PiMovs control module. Further, in various implementations, the PiMovs control module 250 allows communication between PiMovs units, again via any desired wired or wireless communications techniques, such that multiple PiMovs units can be controlled via access to the PiMovs control module 250 of any of the PiMovs units, and so that data can be shared between PiMovs units.

In various implementations, the PiMovs control module 250 also provides administrative control over various operational parameters of the PiMovs System. Examples of such operational parameters include, but are not limited to which applications are being executed or implemented by the PiMovs System, such as games, communications applications, etc. Other examples include setting operational parameters and administrative functions, including, but not limited to enabling local or remote access, setting interaction zone distances for tracking or receiving inputs from users, setting a maximum number of users with which the PiMovs System will interact, selecting applications or application parameters, setting or selecting text overlays to be displayed on the contiguous display surface, setting or adjusting audio sources, selecting or defining themes, etc.

2.0 Operational Details of the PiMovs System:

The above-described program modules are employed for implementing various implementations of the PiMovs System. As summarized above, the PiMovs System provides various techniques for implementing a physically interactive manifestation of a volumetric space using contiguous display surfaces covering the exterior of a geometric framework. The following sections provide a detailed discussion of the operation of various implementations of the PiMovs System, and of exemplary methods for implementing the program modules described in Section 1 with respect to FIG. 1 and FIG. 2. In particular, the following sections provides examples and operational details of various implementations of the PiMovs System, including:
An operational overview of the PiMovs System;
Exemplary geometric framework of the PiMovs System;
Exemplary PiMovs tracking, sensing, and rendering devices and hardware;
Exemplary PiMovs interface framework considerations;
PiMovs connectivity;
Volumetric Projections; and
Exemplary PiMovs-based applications and interactions.

2.1 Operational Overview:

As noted above, the PiMovs System described herein provide various techniques for implementing a physically interactive manifestation of a volumetric space using contiguous display surfaces covering, or comprising, the exterior of a geometric framework. Further, the above-summarized capabilities provide a number of advantages and interesting uses.

For example, each side or section of the geometric framework of the PiMovs System is interactive. This interactivity is enabled, in part, through the use of multiple tracking and NUI sensors and input devices that are arrayed around the PiMovs System. This allows the PiMovs System to concurrently track, and receive NUI inputs from, multiple people per side or section of the geometric framework of the PiMovs System. This capability to interact with and respond to multiple people per side or section of the PiMovs System allows virtually limitless modes of interaction to be implemented. The resulting technical effects of such implementations include, but are not limited to, providing improved user interaction efficiency and increased user interaction performance.

For example, if there are four people interacting with each of the four sides of a cube-shaped implementation of the PiMovs System, there could be up to sixteen concurrent, and potentially different, interactive experiences. This number increases exponentially by allowing any two or more of the people interacting with either local or remote PiMovs Systems to share various interactions between different PiMovs Systems. More specifically, beyond the one or many people to one PiMovs System interactions, there are also PiMovs-to-PiMovs interactions that enable any combination of interactions between one or more people via one or more PiMovs systems. Note also that in various implementations, users can interact with one or more features and capabilities of the PiMovs system via mobile apps and the like running on smart phones, tablets, wearable computing devices, or other portable computing devices.

2.2 Geometric Framework:

As noted above, the geometric framework of the PiMovs System is implemented in any desired shape having sidewall sections and optional top and/or bottom sections, thereby forming a 360-degree geometric framework of any desired size. Such shapes include, but are not limited to regular polygons (e.g., pyramids, cubes, octagons, etc.), irregular polygons, curved shapes such as spherical, oval, amorphous, etc. The geometric framework may also include any combination of such shapes, e.g., a cube with a dome or amorphous top.

Regardless of the shape, the perimeter of this geometric framework is wrapped with contiguous display surfaces to cover each section of the perimeter with adjacent display surfaces, or a single continuous or curved surface. Examples of such display surfaces include, but are not limited to translucent or transparent materials for rear projection, fixed or bendable screens or display devices, etc. In other words, each display surface on the perimeter has edges that are adjacent and thus continue or connect to the edges of at least two other display surfaces on the perimeter. As noted above, in various implementations, the contiguous display surface may include one or more single continuous or curved surfaces that form a 360-degree wrapping of the geometric framework. Additional adjacent display surfaces may optionally cover top and/or bottom sections of the framework. Further, in various optional implementations, at least one edge of each display surface along an outer boundary of the optional top or bottom section may be adjacent to, or otherwise connect to, the edges of one or more display surfaces on the perimeter. In other words, in such implementations, the sides and top (and/or the bottom) of the geometric framework are optionally wrapped with display surfaces such that the contiguous volumetric projection continues across all adjacent or contiguous display edges.

For example, consider a cubic PiMovs System comprising five rectangular display surfaces having approximately the same dimensions as each section of the underlying cubic geometric framework (e.g., four side sections and a top section). In this implementation, each of two opposite edges of each display surface on each side section will connect to a corresponding edge of the display surface on the adjacent side section. In addition, the four edges of the display surface on the top section will connect to one of the edges of each of the display surfaces on the side sections of the geometric framework. In other words, the sides and top of this exemplary cubic PiMovs System are wrapped with display surfaces wherein all adjacent edges are connected.

Further, note that in the case that the display surfaces (e.g., projective materials such as translucent glass, acrylic panels, etc.) have sufficient structural strength, those display surfaces may be integrally formed or otherwise coupled by joining the edges of such materials in a way that precludes the need for an underlying framework to support the display surfaces. In other words, depending on the materials used, in various implementations, the display surfaces themselves form the underlying geometric framework of the PiMovs System.

For example, a tested implementation of the PiMovs System was constructed in a cubic format, using sidewalls and a top constructed of clear acrylic panels. A rear projective surface (i.e., panel faces on the interior of the cube) of each of these clear acrylic panels was coated with a flexible rear-projection neutral gain, high-contrast material applied as a laminate. This configuration enabled the PiMovs System to use projectors arrayed inside of the cube to project images and/or video onto the rear surface of each acrylic panel, with those images and/or video then being clearly visible from the front surface of the acrylic panel (i.e., from the exterior of the cube).

In addition, the edges and corners of this acrylic cube were carefully joined to preserve the optical properties of the acrylic at those seams, thereby minimizing optical distortion of the volumetric projection at the seams. This allowed the PiMovs System to render a full seamless display of the volumetric projection on the projective surfaces of the cube using the projectors inside of the cube, as noted above. Further, in various implementations, the volumetric projection provided by PiMovs System is adaptively warped in the proximity of corners or other non-planar connections between sections of the contiguous display surface to minimize any optical distortions resulting from those corners or non-planar connections.

In various implementations, the geometric framework of the PiMovs System can be placed on the ground or other surface, such as a fixed or rotating base, for example. One of the advantages of placing the geometric framework of the PiMovs System on a base is that some or all of the hardware associated with the PiMovs System, e.g., projectors, computers, tracking sensors, NUI sensors and input devices, sound systems, cameras, etc., can be placed into, or otherwise coupled to, that base. Further, in various implementations, the geometric framework of the PiMovs System may be raised or suspended using cables or other support structures. As with the base, any cables or other support structures for raising or suspending the geometric framework of the PiMovs System can be used to move or rotate the geometric framework. In either case, the movement or rotation of the geometric framework is performed either on some predefined schedule or path, or is performed in response to user interaction with the PiMovs System. The resulting technical effects of such implementations include, but are not limited to, providing improved user interaction efficiency and increased user interaction performance.

2.3 PiMovs Tracking, Sensing, and Rendering Hardware:

As noted above, various implementations of the PiMovs System include a geometric framework wherein each section is covered with display surfaces. Advantageously, in the case of fixed flat-screen or bendable displays, or projective display surfaces for use with rear projection hardware, the interior of the PiMovs System provides a space within which a wide variety of equipment can be placed without interfering with the volumetric projection. The resulting technical effects of such implementations include, but are not limited to, providing physical parameters or controls for improving physical and process security by positioning such hardware in non-visible or otherwise secure locations. However, it should be understood that while placing such hardware in the interior of the PiMovs unit serves to both protect and hide that hardware from view, some or all of this hardware may be placed in visible positions on or near the exterior of the PiMovs system without materially changing the general functionality of the PiMovs System.

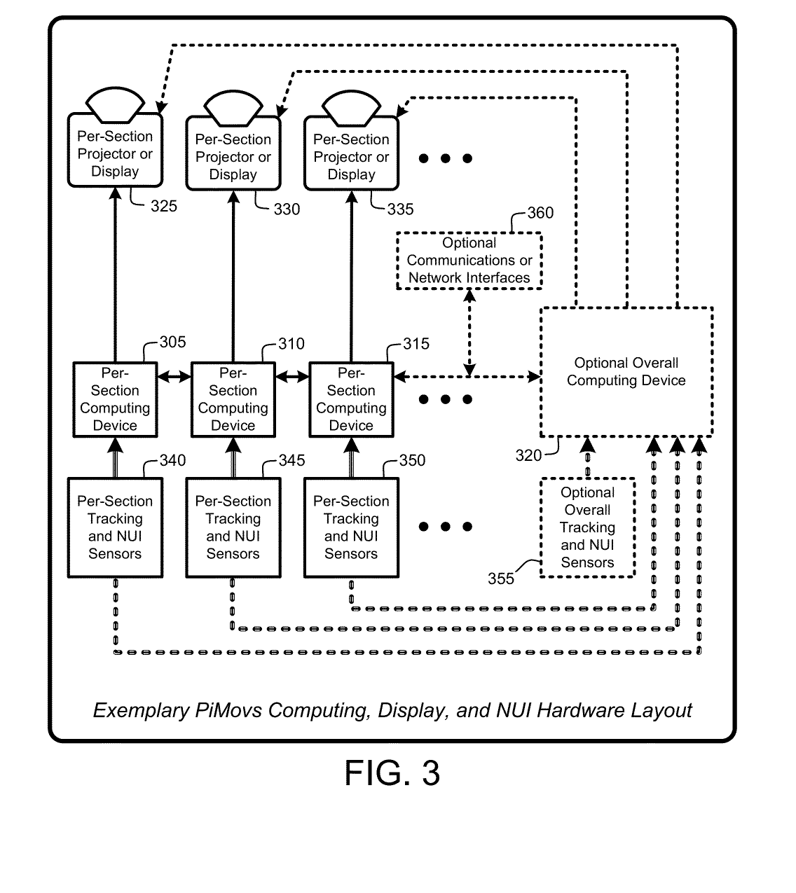

For example, FIG. 3 illustrates exemplary hardware placed within a PiMovs unit for use in implementing the PiMovs System. This exemplary hardware includes, but is not limited to, various computing, display, tracking and NUI hardware devices. In this example, a plurality of per-section computing devices (e.g., 305, 310 and 315) generate or otherwise render each individual section of the overall volumetric projection. However, although not illustrated here, it should be understood that multiple NUI hardware devices may be connected to single computing devices, or single NUI hardware devices may be connected to multiple computing devices. Alternately, or in combination, an optional overall computing 320 generate or otherwise renders some or all of the overall volumetric projection. In either case, the resulting volumetric projection is then passed to a plurality of per-section projectors or display devices (e.g., 325, 330, and 335) for presentation on the display surfaces covering (or comprising) the geometric framework of the PiMovs System.

The displayed volumetric projection is then dynamically updated in response to tracking information and/or NUI inputs received via one or more per-section tracking and NUI sensors (e.g., 340, 345 and 350). Alternately, or in combination, a set of overall tracking and NUI sensors 355 can provide tracking information and NUI inputs to the optional overall computing device 320 for use in dynamically updating the volumetric projection. Communication between the tracking and NUI sensors (e.g., 340, 345 and 350) and the computing devices (e.g., 305, 310, 315 and 320) is accomplished using any desired wired or wireless communication protocol or interfaces. Examples of such communications protocols and interfaces include, but are not limited to sensor data streaming via UDP, TCP/IP, etc., over wired or wireless interfaces (e.g., near-field communications, IR-based input devices such as remote controls or IR-capable smartphones, Ethernet, USB, FireWire®, Thunderbolt™, IEEE 802.x, etc.).

Note also that various implementations of the PiMovs System include a variety of optional communications or network interfaces 360. The optional communications or network interfaces 360 allows any of the per-section computing devices (e.g., 305, 310 and 315) and the optional overall computing device 320 to coordinate rendering and projection or display of the sections of the volumetric projection. Further, the optional communications or network interfaces 360 allows any of the per-section computing devices (e.g., 305, 310 and 315) and the optional overall computing device 320 to send and receive data for interacting with other PiMovs units.

In addition, the optional communications or network interfaces 360 allows any of the per-section computing devices (e.g., 305, 310 and 315) and the optional overall computing device 320 to send or receive data to or from a variety of sources (e.g., cloud based storage, public or private networks, the internet, etc.) for any desired purpose or application. Note also that any of the computing devices (e.g., 305, 310, 315 and 320) can operate in a client/server model where one or more computing devices are associated with dedicated sensor devices, and another computing device acts as a server to process the data and coordinate generation of the volumetric projection.

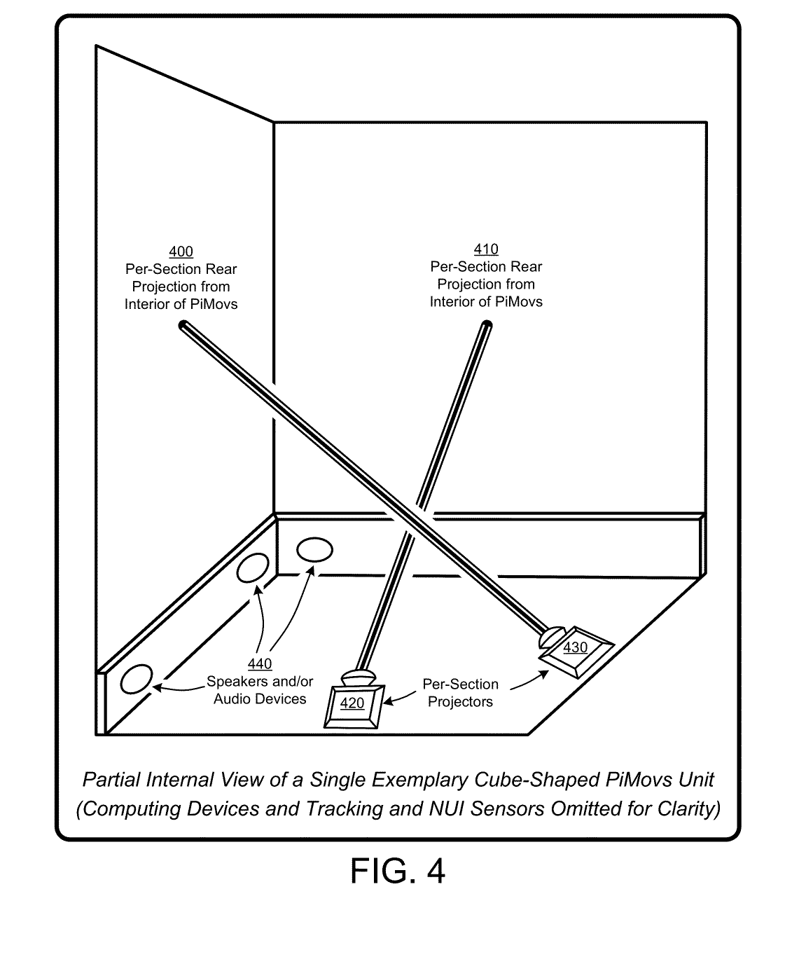

FIG. 4 provides a partial internal view of a single exemplary cube-shaped PiMovs unit, where computing devices and tracking and NUI sensors have been omitted for clarity. In particular, in the case of rear projection onto the rear face of display surfaces (e.g., display surfaces 400 and 410), one or more per-section projectors (e.g., 420 and 430) are positioned in the interior of the geometric framework so as to project sections of the overall volumetric projection onto one or more corresponding sections of display surfaces covering the geometric framework. These projectors are controlled by one or more computing devices, as noted above, with the resulting volumetric projection being dynamically adapted to tracked user motions and/or user NUI inputs. In addition, as illustrated, the PiMovs System optionally includes one or more speakers or audio devices 440.

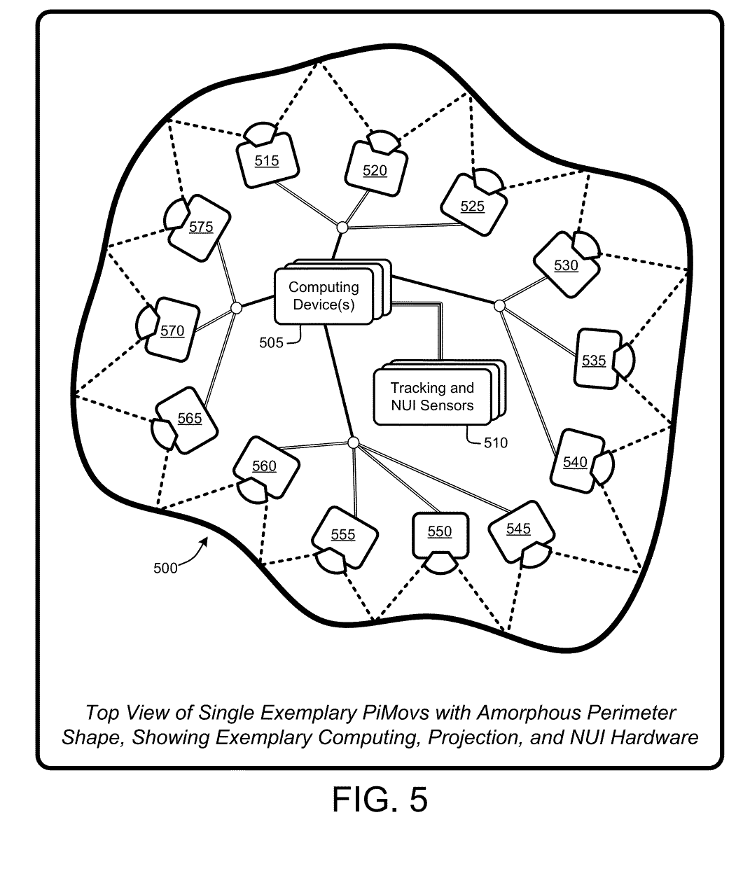

Similarly, FIG. 5 provides a top view of single exemplary PiMovs unit showing exemplary computing, projection, and NUI hardware. In contrast to the exemplary PiMovs unit illustrated by FIG. 4, the PiMovs unit illustrated by FIG. 5 is effected using an amorphous perimeter shape 500. The volumetric projection output by a plurality of per-section projection devices (e.g., 515 through 575) is controlled by computing devices 505 in response to tracking and user NUI inputs received from tracking and NUI sensors 510.

2.3.1 Tracking Sensors:

As noted above, the PiMovs system uses any of a variety of tracking sensors and techniques to monitor what people are doing, where they are at, and to track their motions. Note that such tracking is defaulted to an anonymizing state such that faces and other identifying information is neither collected nor considered by the PiMovs System. However, in various implementations, users may grant explicit permission to allow the PiMovs System to capture and use varying levels of identifying information to be used for particular applications. Further, as noted above, in various implementations, users can interact with one or more features and capabilities of the PiMovs system via mobile apps and the like running on smart phones, tablets, wearable computing devices, or other portable computing devices.

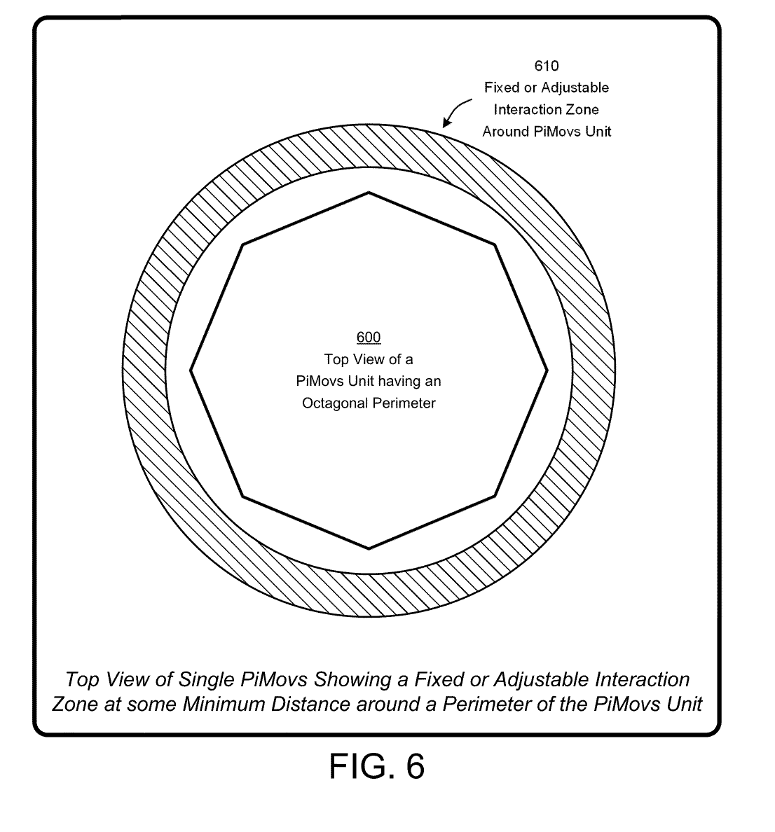

In general, sensors used for tracking and NUI inputs tend to operate well within certain distances or ranges. As such, in various implementations, the PiMovs System optionally limits user tracking and/or NUI inputs to a particular range or zone around individual PiMovs units. For example, as illustrated by FIG. 6, in one implementation, a PiMovs unit 600 having an octagonal perimeter includes a fixed or adjustable interaction zone 610 around the perimeter of the PiMovs unit. In this example, users either inside or outside of the minimum distance indicated by the fixed or adjustable interaction zone 610 are not tracked or monitored for NUI inputs.

Regardless of whether an interaction zone is used, the tracking sensors and techniques are used to track user skeleton data, body positions, motions and orientations, head position, gaze, etc., relative to the position of the PiMovs unit, other users, or other objects within sensor range of the PiMovs System. Any desired tracking or localization techniques using positional sensors or combinations of sensor hardware and software-based techniques can be used for such purposes. Examples include, but are not limited to any desired combination of 2D or stereoscopic cameras, depth sensors, infrared cameras and sensors, laser-based sensors, microwave-based sensors, pressure mats around the PiMovs unit, microphone arrays for capturing speech or using directional audio techniques for various user tracking purposes, user worn or carried sensors, including, but not limited to, GPS sensing or tracking systems, accelerometers coupled to mobile devices worn or carried by the user, head worn display devices, head-mounted or worn virtual reality devices, etc.

2.3.2 NUI Sensors:

In various implementations, the PiMovs System uses any desired combination of sensors, to capture or otherwise receive or derive NUI inputs from one or more users. Advantageously, some or all of the sensors used for tracking users relative to PiMovs units (see discussion above in Section 2.3.1) can also be used to receive NUI inputs. The resulting technical effects of such implementations include, but are not limited to, providing improved tracking and user interaction efficiency and increased user interaction performance. In general, NUI inputs may include, but are not limited to:
a. NUI inputs derived from user speech or vocalizations captured via microphones or other sensors, and optionally including directional audio tracking using microphone arrays and the like to track one or more users;
b. NUI inputs derived from user facial expressions, from the positions, motions, or orientations of user hands, fingers, wrist, arm, legs, body, head, eyes, etc., captured using imaging devices such as 2D or depth cameras (e.g., stereoscopic or time-of-flight camera systems, infrared camera systems, RGB camera systems, combinations of such devices, etc.);
c. NUI inputs derived from gesture recognition, including both air and contact-based gestures, gestures derived from motion of objects held by users (e.g., wands, sports equipment such as tennis rackets, ping pong paddles, etc.);
d. NUI inputs derived from user touch on various surfaces, objects or other users;
e. NUI inputs derived from hover-based inputs or actions, etc.;
f. NUI inputs derived from predictive machine intelligence processes that evaluate current or past user behaviors, inputs, actions, etc., either alone or in combination with other NUI information, to predict information such as user intentions, desires, and/or anticipated actions.

Regardless of the type or source of the NUI-based information or inputs, such inputs are then used to initiate, terminate, or otherwise control or interact with one or more inputs, outputs, actions, or functional features of the PiMovs System and/or any applications being run by any of the computing devices associated with the PiMovs System.

Further, in various implementations, one or more display surfaces of the PiMovs System allow direct user input. For example, in various implementations, one or more of the display surfaces are touch-sensitive (e.g., resistive or capacitive touch, optical sensing, etc.). Further, in various implementations, one or more of the display surfaces are flexible to allow users to push, pull, or otherwise deform those surfaces, with the resulting deformations providing direct interaction with the underlying volumetric projection being displayed on those display surfaces. In other words, these types of touch and user deformations can be used as NUI inputs for interacting with content rendered on one or more display surfaces and with respect to local or remote PiMovs Systems.

2.4 PiMovs Interface Framework:

In general, since the volumetric projection rendered on the display surfaces of the PiMovs System change in response to user tracking and NUI inputs, every interactive experience deployed on the PiMovs System will tend to differ from any other interactive experience on the PiMovs System depending on how the user responds to or interacts with those volumetric projections.

In various implementations, the PiMovs System adapts to such differing inputs by using an interface framework that supports a wide range of inputs and application designs. For example, in various implementations, the PiMovs System provides a wide range of coding environments and graphics frameworks. Such coding environments and graphics frameworks, include, but are not limited to, any desired open source coding environment or graphics framework and any of a wide variety of proprietary coding environments and graphics frameworks such as, for example, Java-based coding and frameworks, C++ based openFrameworks, Unity-based development ecosystems, etc. However, it should be understood that the PiMovs system is not intended to be limited to the use of any particular open source or proprietary coding environments and graphics frameworks.

In various implementations, the PiMovs System provides a framework utility that provides a unified process for broadcasting tracking and NUI sensor data streams to various display applications being executed by the PiMovs System. For example, in various implementations, a minimal server type application running on any computing device associated with the PiMovs System is used to translate the input from any of the sensors into an easy to consume and flexible network broadcast that can be consumed and acted on by any of the computing devices associated with the PiMovs System. Examples of the content of such broadcasts include information such as specific user actions, motions, NUI inputs, etc., relative to either some particular portion of the volumetric projection, or to other particular users.

Further, in various implementations, the PiMovs System combines one or more NUI sensor data streams into a cohesive view of the space around the PiMovs System. This enables a wide range of implementations and applications, including, but not limited to tracking one or more persons walking around the PiMovs System such that they would not be entering and leaving individual NUI sensor areas, but staying within the cohesive view at all times. Advantageously, this keeps the NUI data “seamless,” adding to the seamless nature of the volumetric projection rendered on the contiguous display surface of the PiMovs System. The resulting technical effects of such implementations include, but are not limited to, providing improved user interaction efficiency and increased user interaction performance.

For example, in various implementations, the PiMovs System optionally adapts an Open Sound Control (OSC) protocol for networking sound synthesizers, computers, and other multimedia devices is used by the PiMovs System for broadcasting sensor data. In general, OSC is built on top of a User Datagram Protocol (UDP) that provides a TCP/IP implementation that is useful in various interactive art frameworks. In such cases, data messages are formatted with a routing address followed by a variable number of typed arguments.

In various implementations, the PiMovs System provides an application programming interface (API) or other application or interface that operates to translate or otherwise convert hand or finger motions, or other gestural NUI inputs, within sensor range of the PiMovs System to touchscreen and/or pointing device events or inputs. This allows the PiMovs System to use or interact with any existing program or application as if those programs or applications were receiving inputs via whatever input source was originally intended or anticipated for those programs or applications. For example, in various implementations, the PiMovs System translates hand position received from NUI sensors to instruct an operating system associated with the PiMovs System to move a mouse cursor. Similarly, in various implementations, the PiMovs System translates hand gestures, such as a closed fist, for example, as a touch event (like a user touch on a touchscreen or other touch-sensitive surface) at the current cursor position. Such touch events may then be translated into a corresponding “mouse down” or click event or the like.

2.5 PiMovs Connectivity:

As noted above, in various implementations, the PiMovs System provides a networked, interactive public object. Further, such interaction can occur between any two or more PiMovs units regardless of where those units are located, so long as a communications or networking path exists between those PiMovs units. The result of such interaction between PiMovs units is an interactive ecosystem in which content, interactions, and experiences can be shared by multiple users across the world, and even in space-based locations.

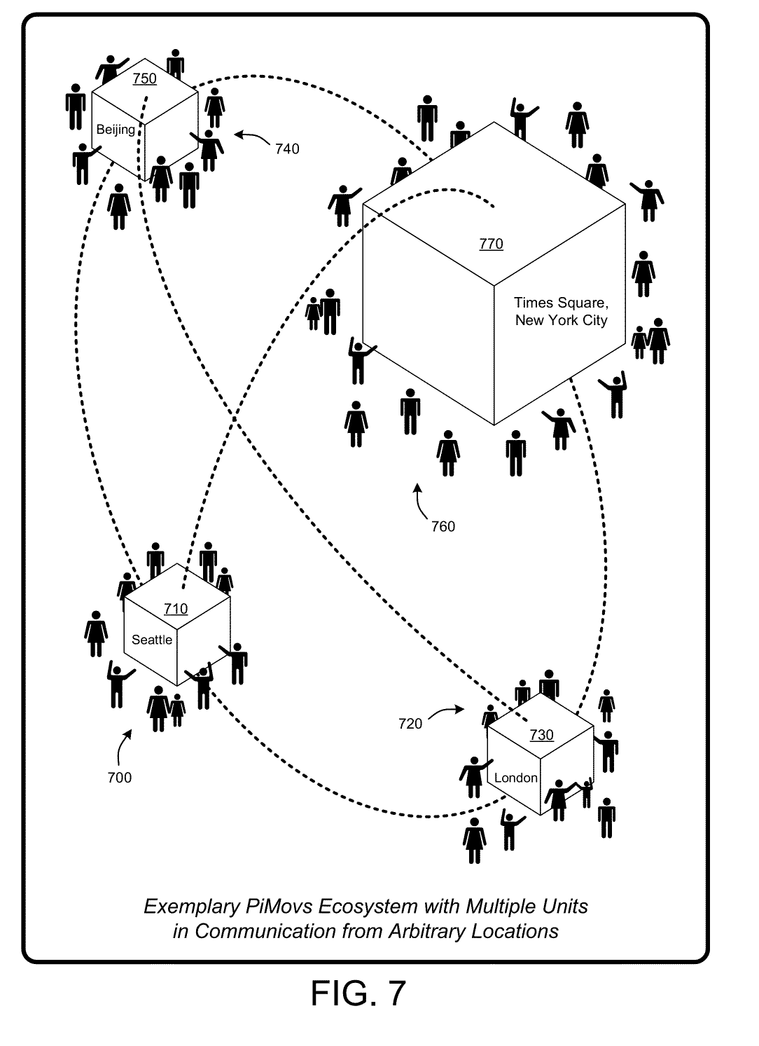

For example, FIG. 7 provides an illustration of an exemplary PiMovs ecosystem showing multiple users interacting with individual PiMovs units that are in communication from arbitrary locations. For example, in the illustration of FIG. 7 multiple users 700 are interacting with the volumetric projection rendered on a PiMovs unit 710 in Seattle. FIG. 7 also shows multiple users 720 interacting with the volumetric projection rendered on a PiMovs unit 730 in London. FIG. 7 also shows multiple users 740 interacting with the volumetric projection rendered on a PiMovs unit 750 in Beijing. Finally, FIG. 7 also shows multiple users 760 interacting with the volumetric projection rendered on a relatively much larger PiMovs unit 770 in Times Square in New York. In the example of FIG. 7, each of the PiMovs units (710, 730, 750 and 770) are communicating via wired and/or wireless network connections. Advantageously, the communications capabilities of the PiMovs system enables users of each of the PiMovs units illustrated in FIG. 7 to jointly interact with a common volumetric projection that may be displayed on some or all of those PiMovs units.

Note also that in various implementations, users interacting with a section of the volumetric projection on any side, face or section of one PiMovs System may interact with users in another location that are interacting with a section of the volumetric projection on any side, face or section of the PiMovs System in that location. Further, each side, face, or section of any PiMovs System may interact with sides, faces, or sections of different PiMovs systems such that any particular PiMovs System may be in communication and interacting with multiple PiMovs System at any time.

As noted above, in various implementations, the PiMovs System provides various communications capabilities for interacting with portable computing devices, including, but not limited to, smartphones, tablets, media devices, remote controls, pointing devices, etc. Communications technologies for enabling interaction and communication between the PiMovs System and such portable devices includes, but in not limited to RFID or other near-field communications, IR-based communications, Bluetooth®, Wi-Fi (e.g., IEEE 802.11 (a/b/g/n/i, etc.), Global System for Mobile Communications (GSM), General Packet Radio Service (GPRS), various code division multiple access (CDMA) radio-based techniques, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (i.e., IS-136/TDMA), Integrated Digital Enhanced Network (iDEN), etc.

In various implementations, communications capabilities such as those noted above enable the PiMovs system to push or otherwise transmit data or information to various portable computing devices carried by users, and also enables those devices to pull information from the PiMovs System. One simple example of such capabilities is to use sensors embedded in, coupled to, or otherwise in communication with a portable computing device, such as a smartphone, for example, to provide sensor data or to input or share other data or user personalization information with the PiMovs System. Another simple example of such capabilities includes, but is not limited to, displaying one or more Quick Response (QR) codes, or other scannable codes, as overlays on the volumetric projection, or as image elements otherwise included in the volumetric projection. Users can then use portable computing devices having camera capability to scan such codes to allow those computing devices to provide a second-screen experience, or alternately, to automatically retrieve related data (e.g., download files, information, links, etc., or open webpages or the like).

2.6 Volumetric Projections:

Existing panoramas or virtual reality “rooms” often stitch together views of an exterior space or scene that is then viewed as if the user were in the interior of that space. In other words, panoramas and virtual reality rooms often provide an image or video replay representing a stitched panoramic view of some space.

In contrast, the volumetric projection provided by the PiMovs System represents a view that appears to viewers as content that is displayed on the interior of the geometric framework, and which is observable by viewers from the exterior of the geometric framework. This visual impression is maintained because each face or section of the geometric framework may display the content of the volumetric projection from a different perspective, and because the volumetric projection completely and seamlessly wraps the entire perimeter and, optionally, the top and/or bottom surfaces of the geometric framework. The result is that some or all of the volumetric projection appears to users as a rendering of 2D and/or 3D content inside of the geometric framework, even as the users move around the outside of that framework.

More specifically, the volumetric projection of the PiMovs System may include 2D or 3D content, or any desired combination of 2D and 3D content. The content of the volumetric projection is automatically adapted to tracked positions of users as those users move, view, or otherwise interact with the volumetric projection. In various implementations, this automatic adaptation of the volumetric projection also includes, but is not limited to changing the perspective of the volumetric projection based on user positions and viewing angles relative to the PiMovs System.

2.6.1 Perspective Views and Position Tracking:

As noted above, in various implementations, as users walk around or move relative to the PiMovs System, the perspective changes so that a virtual object or other content of the volumetric projection appears as it were in a consistent physical space or location inside of the geometric framework. This is not the same as merely showing a different camera angle on each screen or display surface. Instead, one or more sensors associated with the PiMovs System actively track individual people or groups of people, and/or each person's head, and then actively changes a virtual camera angle per screen or display surface so that perspective changes, even across individual screens, as a person moves relative to the PiMovs System. In various implementations, this same perspective issue is solved for multiple people per screen or display surface by using active shutter glasses or the like, or polarized screens or the like in combination with multiple projectors per display surface. This enables people looking at the same display surface from different angles to see different images or different perspectives of the same image depending on their relative viewing angles.

For purposes of explanation, the following example describes a case of a cubic PiMovs System with a single user viewing a cubic PiMovs System having four sides. Note that the following example may be extrapolated to additional viewers per side and to additional sides of a multi-sided PiMovs System.

For example, consider the case of a single user viewing a four-sided PiMovs System, with one or more computers jointly controlling each tracking sensor and the portion of the volumetric projection rendered on each display surface. In this case, the sensor data stream is combined into a real-time unified view of user movement in the PiMovs' surroundings, based on any combination of user eye position, user head position, and/or user skeleton position. This real-time user tracking information is then used by the PiMovs System to dynamically modify any display surfaces visible to the tracked user, and to show a correct perspective view of the content of the volumetric projection to that user. In other words, in this example, the contents of the volumetric projection will appear to the viewer as a seamless representation of content in a virtual space that appears to exist within the interior of the PiMovs System, and that transitions seamlessly between the display surfaces as the user moves around the exterior of the geometric framework of the PiMovs System.

One of the various ways in which such capabilities may be implemented is to consider virtual bounding boxes of the same size as, and thus covering, each face or section (e.g., each display surface) of the PiMovs System. Each virtual bounding box then surrounds one or more objects, scenes, or other content being rendered on a corresponding face or section of the volumetric projection. Note that for purposes of discussion the content being rendered (i.e., objects, scenes, or other content) will be referred as an object.

A virtual ray-tracing camera is then oriented towards the object from a point in space corresponding to an origin of the point of view of the tracked user. A large number of virtual rays are then projected forward from the virtual ray-tracing camera towards the object to cover a field of view representing a corresponding display surface of the PiMovs System. The position where each virtual ray intersects the virtual bounding box covering the corresponding face or section of the volumetric projection is then automatically identified, along with the corresponding color of any visible texture hit by the virtual ray.

The identified intersection color of each virtual ray is then used to update a virtual visible box (covering the corresponding face or section of the volumetric projection) in the same location that those rays intersected the virtual bounding box. Around this virtual visible box are four virtual cameras in fixed virtual positions, one to each side of the cube. Each virtual camera virtually captures the image of the updated virtual visible box from its fixed virtual position and then renders that virtually captured image to the corresponding physical display of the PiMovs System.

Then, as the person moves, the virtual ray-tracing camera moves with the tracked viewpoint of the user, but continues to point toward the object. The processes described above are then continually repeated so that the actual volumetric projection is continually updated in real-time as the user moves around the exterior of the geometric framework of the PiMovs System.

Further, in this example of a cubic PiMovs System, a maximum of two of the sides (assuming that user is standing at or near a corner) will be visible to the user. Consequently, in various implementations, sides not visible to the user may display default views, no views, or may display perspective views based on tracking of a different user.

2.6.2 Stereoscopic and 3D Display Considerations:

In general, content of some or all of any portion of any volumetric projection may include 3D content rendered using stereoscopic projectors or the like to project stereoscopic images and/or video onto one or more display surfaces. In such implementations, depending on the particular type of 3D technology being used, user's wearing passive 3D glasses or active shutter glasses (e.g., fast left/right eye switching glasses) will see the volumetric projection as actual 3D content. Further, some fixed or passive 3D display devices allow users within a certain range or viewing angle of 3D monitors to view content in 3D without the use of 3D glasses or active shutter glasses. Consequently, one or more sections (or subsections) of the geometric framework can be tiled, wrapped or otherwise covered with such 3D type devices to include full or partial 3D viewing capabilities for some or all of the display surfaces of the geometric framework of the PiMovs System. In various implementations, the PiMovs System modifies the volumetric projection to improve stereoscopic or 3D content of the volumetric projection by adding parallax and kinesthetics to techniques for changing viewing perspective in 3D that is commonly used in computer gaming and movies. Further, the use of separate left and right images for each eye causes the human brain to perceive depth, or 3D content, in the volumetric projection.

Interestingly, in various implementations, one or more 3D monitors can be inserted or otherwise integrated into different sections of a larger display surface of the geometric framework. Consequently, head and/or eye tracking of individual users can be used to change a “virtual camera angle” of the scene of the volumetric projection for those individual users with respect to the corresponding 3D monitor inserts. As a result, depending on where a user is standing or looking, individual users may experience a 3D window into smaller parts of the overall volumetric projection. Conversely, the entire geometric framework can be wrapped or covered with 3D monitors, with some or all of the volumetric projection then being rendered and displayed in 3D via those 3D monitors.

2.7 Exemplary Applications and User Interaction Scenarios:

As noted above, the capability to interact with and respond to multiple people per side or section of the PiMovs System allows virtually limitless modes of interaction and applications to be implemented. A few of examples of such applications are discussed in the following paragraphs. It should be understood that the example applications presented are discussed only for purposes of explanation, and that these example applications are not intended to limit the use of the PiMovs System to the types of example applications described.

2.7.1 Shape-Shifter Application:

As noted above, every interactive experience enabled by the PiMovs System will be different. For example, one application enabled by the PiMovs System is a shape-shifting application where users see themselves as a dynamically mirrored but altered abstraction (e.g., user as a vampire, user as a centaur, user dressed in different clothes, user walking on the moon, etc.).

In various implementations, these altered abstractions are rendered into the overall volumetric projection. In such applications, motions such as, for example, moving, jumping, waving, or simply walking past the PiMovs System cause the movements of the altered abstraction to be mapped to the user's movements via the tracking capabilities of the PiMovs System. Further, in various implementations of this application, users moving to different sides of the geometric framework will see a further shape-shift into other various abstractions.

Further, the types of abstractions used for such purposes can change depending on the detected age, gender, race, etc. of one or more users. For example, changing the mirrored image (i.e., the altered abstraction) of a user to look like a frightening werewolf may be appropriate for a teenage user, but not for a user that is a young child (which might be more appropriately mirrored as a butterfly or some other non-threatening abstraction).

Some additional options and modes for various implementations of the shape-shifting application are briefly summarized below.
a. Invitation Mode: In various implementations, each PiMovs unit displays a theme-based volumetric projection to invite user attention and interaction. In various implementations, this theme is either manually selected, or automatically selected in response to the external environment around the PiMovs unit and/or people within that environment. For example, when there is no activity around the PiMovs unit, one or more animals, creatures, people, etc., falling within a particular theme (e.g., endangered animals of the Serengeti Plain, fantasy creatures, famous figures from history, space aliens, etc.) periodically flies, runs or walks across a face of the PiMovs unit to generate curiosity for people walking past.
b. Alternative Universe: As the space around the PiMovs System becomes more active, animals emerge from their group (on their respective display surfaces of faces of the geometric framework) to map their pace and placement in space to in-range passersby. If a user slows their pace or stops, the animal will mirror this. In various embodiments, users may then converse with the animals using natural language processing or other language-based computer interaction techniques. For example, a user may ask a wild boar where the nearest BBQ restaurant is located. The boar can then respond in recorded or synthesized speech, and may display a map or directions to the restaurant.
c. Magic Corners: To encourage flow around the geometric framework of the PiMovs System, in various applications, turning a corner will trigger a shape-shift into another animal within that PiMovs System theme. The other faces of the PiMovs System reflect the same interaction model, however with different animals (falling under the PiMovs System theme). When a user leaves or after a certain amount of time, an animal will walk off to its group, signaling the end of the interaction.
d. Abstract or Artistic Representation: The animals can be depicted as visually arresting artist abstractions to present an otherworldly and playful experience.
e. Animal Parades: In various implementations, one or more PiMovs Systems operate to promote curiosity, and potentially visitation to other PiMovs Systems by rendering a parade of the animals or creatures from associated with different PiMovs Systems across the world by having those animals or creatures playfully march across the volumetric projection rendered on the PiMovs System.
f. Public Events: PiMovs Systems can be placed at events such as the Olympics or Burning Man. The creatures or theme may change accordingly (e.g., Olympic mascots, aliens, sports stars, etc.)

2.7.2 Shared Digital Art Application:

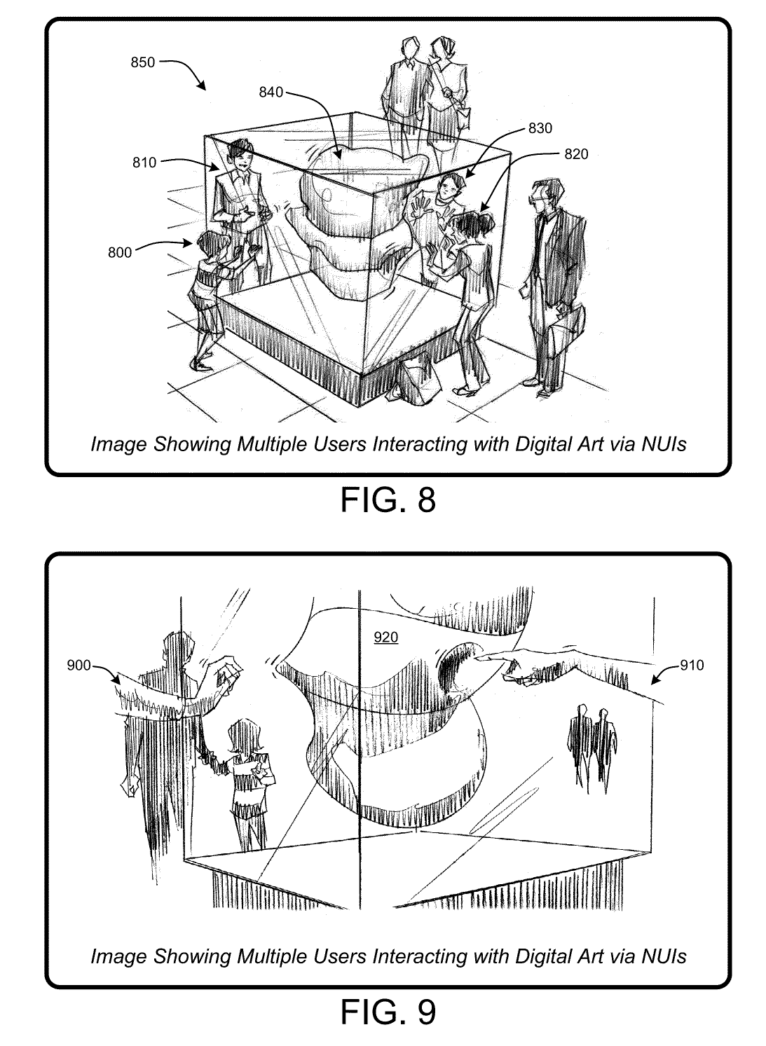

Another application enabled by the PiMovs System allows multiple users to interact or collaborate with others both locally and from around the world on a virtual block of digital “clay,” directly showcasing real time interaction and decentralizing the notion of “artist.” FIG. 8 and FIG. 9 illustrate simple examples of this application.

In particular, FIG. 8 shows multiple users (800, 810, 820 and 830) using various hand-based gestures as NUI inputs to shape the digital clay 840 presented as a dynamic volumetric projection on the display surfaces of the PiMovs System 850. Similarly, FIG. 9 shows a close-up of a similar digital art interaction where multiple users (900 and 910) are using various hand-based gestures as NUI inputs to shape the digital clay 920.

Some additional options and modes for various implementations of the shared digital art application are briefly summarized below.
a. PiMovs System as a Collaborative Sandbox: PiMovs units in different cities act as portals to one collaborative play area. Each city interacts with a specific-colored set of the “clay” that represent a portion of a larger multi-city collaboration.
b. Real-Time Collaboration: Many participants around a PiMovs unit interact with their part of the model (identified through color) and can see how their city's pushing and pulling affects the larger picture through the dynamically adapting volumetric projection. All participants see how other cities are interacting with their respective portion of the collaboration.
c. Gestural Manipulation: One city's section of the “clay” (e.g., specified by color) can be pushed or pulled gesturally and seen real-time.
d. Mother Display: A “mother” or primary PiMovs unit renders an overall volumetric projection of the artwork created by the joint manipulation of the “clay” by users in each of the different cities. In various implementations, the mother PiMovs unit creates beautiful moments with a time-lapse of the artistic collaboration between several cities. The timespan covered by this time-lapse can be measured in minutes, hours, days or even weeks, thus creating a continuous morph of the work from all around the world.

2.7.2 Virtual Portal:

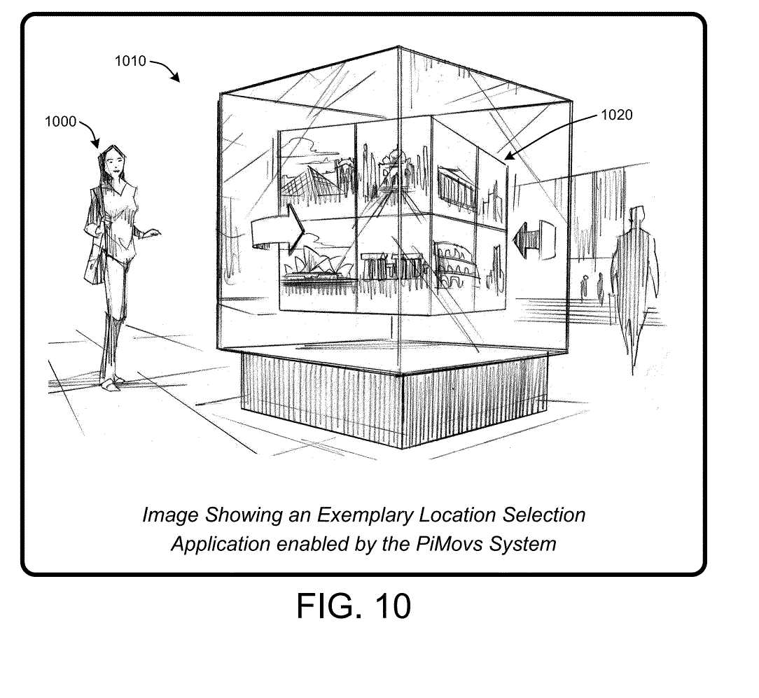

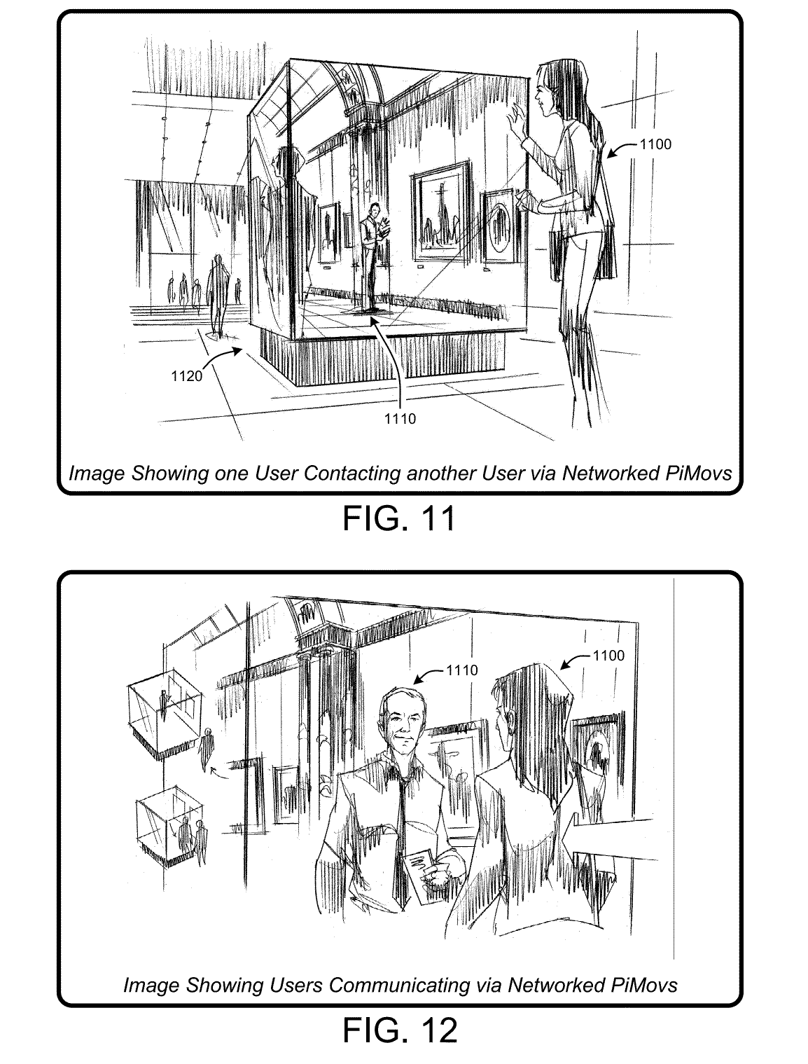

Another application enabled by the PiMovs System offers users a virtual transport to a new place to converse on a large-scale, and then an intimate one, to inhabit a space and build spontaneous community. Note that because the sensors track people and use cameras, in various implementations, the PiMovs System will blur out people rendered in a volumetric projection of another PiMovs unit in real-time to protect privacy. As a result, a user may see another person (via a volumetric projection from another place), but not be able identify the face of that other person. However, users can remove the scrambling algorithm from their own faces if they want so that others can see and possibly interact with them. Some specific examples and additional options and modes for various implementations of the virtual portal application are briefly summarized below.
a. Location Selection “Roulette”: When no one has approached the PiMovs unit, it appears alive with all the possibilities for portals into other PiMovs units around the world. Once approached, or if people are within a certain range, the PiMovs unit enters into “Roulette” mode as it searches for a portal to a different cube that meets search criteria. Examples of such criteria include, but are not limited to activity around other PiMovs units, age of visitors so children only match with children, requests for specific locations (e.g., “Paris please” or “take me to Portugal”) matching shirt color to some user in another part of the world, etc. FIG. 10 shows an example of this implementation. In particular, FIG. 10 shows 1000 approaching a PiMovs unit 1010. The PiMovs unit 1010 is displaying a volumetric projection 1020 representing a visually rotating grid of available portals to other PiMovs units around the world.
b. Portal into the Louvre (or other Location): As “Roulette” makes a selection, a dimensional portal to the view of a different PiMovs unit opens into that PiMovs unit's place. In other words, the volumetric projection of one PiMovs unit can be transported to another. In various implementations, to draw people in, a visitor's proximity to the PiMovs unit dictates how clear or blurry the portal environment looks. In various implementations, the PiMovs System will isolate people in the portal and make them appear clearly to promote human connection. If there is no one immediately standing at the cube for a conversation, a visitor may be able to get the attention of someone in the portal by waving. In fact, FIG. 11 shows just such an example. In particular, FIG. 11 shows a woman 1100 waving to a man 1110 visible (as a volumetric projection) in the distance through a portal of a PiMovs unit 1120 in a different location. FIG. 12 then continues this example by showing a subsequent face-to-face communication (real-time video, audio, etc.) between the woman 1100 and the man 1110 via two separate PiMovs units. Both the woman 1100 and the man 1110 in this example appear to each other as volumetric projections via their respective local PiMovs units. Further, the speech of each of these people is captured by one or more local PiMovs sensors (e.g., microphones), transmitted to the other PiMovs unit, and then played back via one or more audio output devices or the like.
c. Interface Examples: In addition to proximity, a wink, smile or saying “Hello” makes the environment on the PiMovs unit react and become crisp, drawing attention and pulling people in. When the interaction is over, or if the user wants to see a new location, stepping back makes the portal blur. Roulette begins again or, if someone else steps into frame, facial recognition will allow the portal to stay open and become crisp for a continued conversation.
d. Human Connection: When a person gets within the proper range for an intimate conversation, the portal on the cube becomes and remains clear. Two people from seemingly different places have a face-to-face conversation using the cube. See discussion and example above with respect to FIG. 11 and FIG. 12.
e. Virtual Connection: If “Roulette” produces no results, then the PiMovs System will generate a “smart” avatar with which users can converse.
f. Real-Time Translations: In various two-user communication scenarios, the PiMovs System uses any of a variety of real-time machine-translation techniques to translate the speech of each user's language to that of the other user. For example, such capabilities allow a native English speaker (or any other language) to converse with a native Mandarin Chinese speaker (or any other language) in real-time via volumetric projections of each user presented to the other user via their respective local PiMovs units.
g. Portal-Based Ball Game: In various implementations, a wide variety of shared game-based applications are enabled by the PiMovs System. For example, in one such game, users use NUI inputs (e.g., hand swipes in the air or the like) as a gesture to “hit” a virtual ball. That ball then bounces to any other face of the local PiMovs unit, or out of that local PiMovs unit to a remote local PiMovs unit so that multiple people can play ball together from multiple different local PiMovs units around the world. When user hits the ball, it is given velocity and direction vector. If there is no user on a particular side, that wall becomes solid and the ball will bounce off. Further, balls can bounce out of the top to another cube. Again, this ball is represented in all associated PiMovs units as a volumetric projection that may be rendered by itself, or superimposed onto whatever volumetric projection is being displayed in the PiMovs unit into which the virtual ball bounces.

3.0 Operational Summary of the PiMovs System:

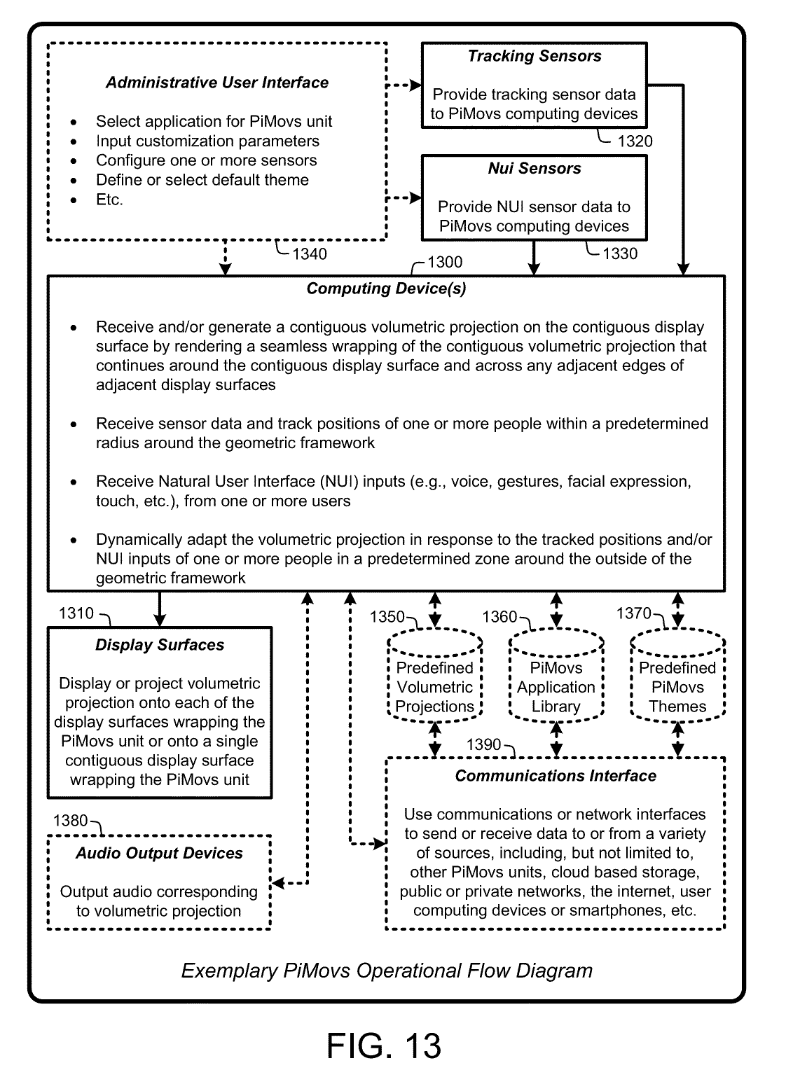

The processes described above with respect to FIG. 1 through FIG. 12, and in further view of the detailed description provided above in Sections 1 and 2, are further illustrated by the general operational flow diagram of FIG. 13. In particular, FIG. 13 provides an exemplary operational flow diagram that summarizes the operation of some of the various implementations of the PiMovs System. Note that FIG. 13 is not intended to be an exhaustive representation of all of the various implementations of the PiMovs System described herein, and that the implementations represented in FIG. 13 are provided only for purposes of explanation.

Further, it should be noted that any boxes and interconnections between boxes that are represented by broken or dashed lines in FIG. 13 represent optional or alternate implementations of the PiMovs System described herein. Further, any or all of these optional or alternate implementations, as described below, may be used in combination with other alternate implementations that are described throughout this document.

In general, as illustrated by FIG. 13, the PiMovs System begins operation by using one or more computing devices 1300 to receive and/or generate a contiguous volumetric projection. As discussed above, this contiguous volumetric projection is rendered on the display surfaces 1310 as a seamless wrapping of the volumetric projection that continues around the contiguous display surface and across any adjacent edges of adjacent display surfaces. Note that in various implementations, the computing devices 1300 receive one or more predefined volumetric projections 1350 from a database or library of volumetric projections and related content.

The one or more computing devices 1300 also receive sensor data from tracking sensors 1320 for use in tracking positions, skeletons, body motions, head, etc., of one or more people within a predetermined radius around the geometric framework. Similarly, the one or more computing devices 1300 also receive one or more NUI sensor 1330 inputs (e.g., voice or speech, gestures, facial expression, eye gaze, touch, etc.), from one or more users within a predetermined radius around the geometric framework. The one or more computing devices 1300 then dynamically adapt the volumetric projection being rendered, projected, or otherwise displayed on the display surfaces 1310 in response to the tracked positions and/or NUI inputs of one or more people in the predetermined zone around the outside of the geometric framework.

In various implementations, an administrative user interface 1340 is provided to enable local or remote management of the PiMovs unit. In general, the administrative user interface 1340 enables system administrators, or users with access rights, to perform a variety of administrative tasks, including, but not limited to, select an application (e.g., from PiMovs application library 1360) to be run or executed by the computing devices 1300 of the PiMovs unit, inputting customization parameters, etc. The administrative user interface 1340 also enables system administrators, or users with access rights, to configure one or more sensors (e.g., tracking sensors 1320 and/or NUI sensors 1330). Further, the administrative user interface 1340 also enables system administrators, or users with access rights, to define or select default theme (e.g., from a database or library of predefined PiMovs themes 1370).

As noted above, in various implementations, the PiMovs system also includes various audio output devices 1380. In general, these audio output devices 1380 (e.g., speakers or audio output channels) simply output audio corresponding to volumetric projection. Note also that these audio output devices 1380 may also be used with various communications type applications (e.g., see discussion above in Section 2.7.2 with respect to FIG. 12).

Finally, in various implementations, the PiMovs System also includes a communications interface 1390 or the like that uses one or more communications or network interfaces to send or receive data to or from a variety of sources, including, but not limited to, other PiMovs units, cloud based storage, public or private networks, the internet, user computing devices or smartphones, etc.

4.0 Claim Support:

The following paragraphs summarize various examples of implementations which may be claimed in the present document. However, it should be understood that the implementations summarized below are not intended to limit the subject matter which may be claimed in view of the detailed description of the PiMovs System. Further, any or all of the implementations summarized below may be claimed in any desired combination with some or all of the implementations described throughout the detailed description and any implementations illustrated in one or more of the figures. In addition, it should be noted that the following implementations are intended to be understood in view of the detailed description and figures described throughout this document.

In various implementations, the PiMovs System provides an interactive display system implemented by means for dynamically adapting a contiguous volumetric projection in response to tracked positions of one or more people as they move around the outside of the geometric framework comprising the interactive display system.

For example, in various implementations, an interactive display is implemented by providing a contiguous display surface arranged to cover or to create a perimeter of a 360-degree geometric framework. In addition, one or more position sensing devices are applied to track positions of one or more people within a predetermined radius around the geometric framework. One or more computing devices are then applied to generate a contiguous volumetric projection on the display surfaces. Further, this contiguous volumetric projection provides a seamless wrapping of the contiguous volumetric projection across any edges of any adjacent display surfaces comprising the contiguous display surface. In addition, the contiguous volumetric projection dynamically adapts to the tracked positions by dynamically adjusting the contiguous volumetric projection in response to the motion of one or more people as they move around the outside of the geometric framework.

Further, the implementations described in any of the previous paragraphs may also be combined with one or more additional implementations and alternatives. For example, some or all of the preceding implementations may be combined with means, processes or techniques for dynamically adapting the contiguous volumetric projection to the tracked positions such that objects within the contiguous volumetric projection appear to occupy a consistent position in space within the geometric framework relative to the one or more people as they move around the outside of the geometric framework.

Further, the implementations described in any of the previous paragraphs may also be combined with one or more additional implementations and alternatives. For example, some or all of the preceding implementations may be combined with means, processes or techniques for implementing the contiguous display surface by including one or more rear projective display panels that are joined together along one or more adjacent edges to form corresponding sections of the geometric framework.

Further, the implementations described in any of the previous paragraphs may also be combined with one or more additional implementations and alternatives. For example, some or all of the preceding implementations may be combined with means, processes or techniques for joining one or more display panels of the contiguous display surface to preserve optical properties of the display panels at the corresponding seams, thereby minimizing optical distortion of the volumetric projection at the corresponding seams.

Further, the implementations described in any of the previous paragraphs may also be combined with one or more additional implementations and alternatives. For example, some or all of the preceding implementations may be combined with means, processes or techniques for arranging or positioning one or more projectors within an interior of the geometric framework to project portions of the volumetric projection on corresponding portions of the rear projective display panels.

Further, the implementations described in any of the previous paragraphs may also be combined with one or more additional implementations and alternatives. For example, some or all of the preceding implementations may be combined with means, processes or techniques for automatically selecting the contiguous volumetric projection from a set of one or more predefined volumetric projections in response to motions of one or more people within a predetermined zone around the geometric framework.

Further, the implementations described in any of the previous paragraphs may also be combined with one or more additional implementations and alternatives. For example, some or all of the preceding implementations may be combined with means, processes or techniques for dynamically adapting the contiguous volumetric projection dynamically to one or more natural user interface (NUI) inputs from one or more people.

Further, the implementations described in any of the previous paragraphs may also be combined with one or more additional implementations and alternatives. For example, some or all of the preceding implementations may be combined with means, processes or techniques for accepting NUI inputs from one or more people within a predefined interaction zone at some minimum distance around the perimeter of the geometric framework.

Further, the implementations described in any of the previous paragraphs may also be combined with one or more additional implementations and alternatives. For example, some or all of the preceding implementations may be combined with means, processes or techniques for providing a communications interface that enables real-time interaction between multiple interactive displays, each of which includes a contiguous volumetric projection.

In additional implementations, a system for displaying volumetric projections is provided via means, processes or techniques for rendering a contiguous volumetric projection on one or more display surfaces forming a perimeter of a contiguous geometric framework, such that the contiguous volumetric projection provides a seamless wrapping of the contiguous volumetric projection across any adjacent edges of any adjacent display surfaces. Such implementations may also receive sensor data and track positions of one or more people within a predetermined radius around the geometric framework. In addition, such implementations may also receive natural user interface (NUI) inputs from one or more of the people within the predetermined radius around the geometric framework. Further, such implementations may also dynamically adapt the contiguous volumetric projection in response to the tracked positions and the NUI inputs.

Further, the implementations described in any of the previous paragraphs may also be combined with one or more additional implementations and alternatives. For example, some or all of the preceding implementations may be combined with means, processes or techniques for dynamically adapting the contiguous volumetric projection to the tracked positions of one or more people such that objects within the contiguous volumetric projection appear to occupy a consistent position in space within the geometric framework relative to the one or more people as they move around the outside of the geometric framework.

Further, the implementations described in any of the previous paragraphs may also be combined with one or more additional implementations and alternatives. For example, some or all of the preceding implementations may be combined with means, processes or techniques for constructing one or more of the display surfaces from rear projective display panels that are joined together along one or more adjacent edges.

Further, the implementations described in any of the previous paragraphs may also be combined with one or more additional implementations and alternatives. For example, some or all of the preceding implementations may be combined with means, processes or techniques for arranging or positioning one or more projectors within an interior of the geometric framework to project contiguous portions of the volumetric projection on corresponding portions of the rear projective display panels.

Further, the implementations described in any of the previous paragraphs may also be combined with one or more additional implementations and alternatives. For example, some or all of the preceding implementations may be combined with means, processes or techniques for implementing a communications interface to provide real-time interaction between multiple instances of the system for displaying volumetric projections, each of which may provide separate, related, or shared contiguous volumetric projections.

Further, the implementations described in any of the previous paragraphs may also be combined with one or more additional implementations and alternatives. For example, some or all of the preceding implementations may be combined with means, processes or techniques for sharing a volumetric projection between two or more of the systems for displaying volumetric projections to provide a dynamic volumetric rendering allowing people to communicate in real-time between those systems.

Further, the implementations described in any of the previous paragraphs may also be combined with one or more additional implementations and alternatives. For example, some or all of the preceding implementations may be combined with means, processes or techniques for sharing a volumetric projection between two or more of the systems for displaying volumetric projections to provide a dynamic volumetric rendering of a real-time interactive virtual ball game that allows one or more people to use NUI gestures to play ball between different instances of the systems.

Further, the implementations described in any of the previous paragraphs may also be combined with one or more additional implementations and alternatives. For example, some or all of the preceding implementations may be combined with means, processes or techniques for applying the volumetric projection to provide a virtual avatar that reacts in real-time to NUI inputs of one or more people within a predetermined radius around the geometric framework.

In additional implementations, a volumetric display device is provided via means, processes or techniques for joining a plurality of adjacent display surfaces together to form a perimeter and a top of a contiguous geometric framework. The volumetric display device applies a computing device for rendering a contiguous volumetric projection as a seamless wrapping across each adjacent edge of each adjacent display surface. The computing device is further applied to receive sensor data for tracking positions of one or more people within a predetermined radius around the geometric framework. In addition, the computing device is applied to dynamically adapt the contiguous volumetric projection in response to the tracked positions such that objects within the contiguous volumetric projection appear to occupy a consistent position in space within the geometric framework relative to the one or more people as they move around the outside of the geometric framework.

Further, the implementations described in any of the previous paragraphs may also be combined with one or more additional implementations and alternatives. For example, some or all of the preceding implementations may be combined with means, processes or techniques for applying the computing device to receive natural user interface (NUI) inputs from one or more of the people within the predetermined radius.

Further, the implementations described in any of the previous paragraphs may also be combined with one or more additional implementations and alternatives. For example, some or all of the preceding implementations may be combined with means, processes or techniques for applying the computing device for dynamically adapting the contiguous volumetric projection in response to one or more of the NUI inputs.

5.0 Exemplary Operating Environments:

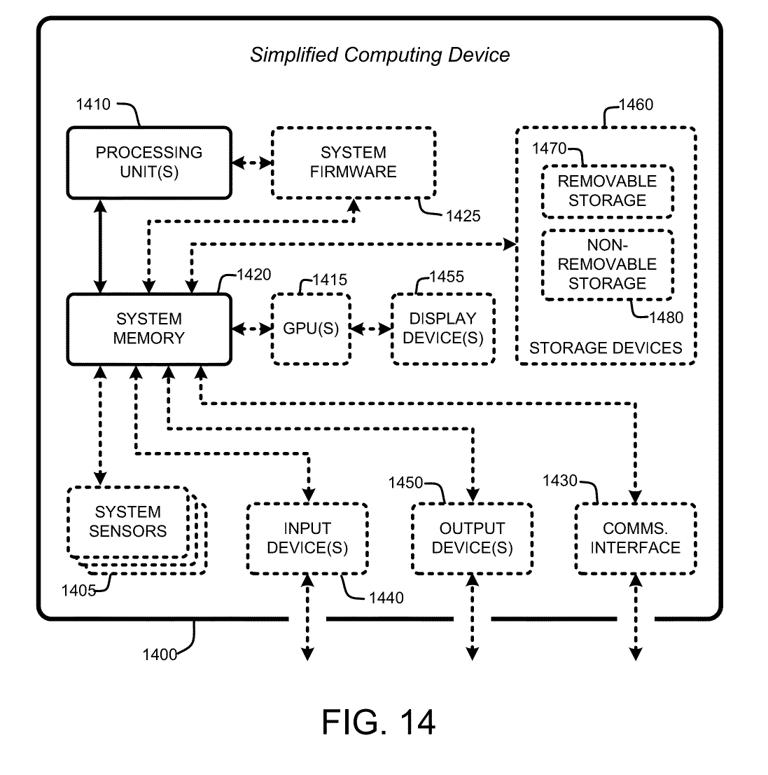

The PiMovs System described herein is operational within numerous types of general purpose or special purpose computing system environments or configurations. FIG. 14 illustrates a simplified example of a general-purpose computer system on which various implementations and elements of the PiMovs System, as described herein, may be implemented. It should be noted that any boxes that are represented by broken or dashed lines in FIG. 14 represent alternate implementations of the simplified computing device, and that any or all of these alternate implementations, as described below, may be used in combination with other alternate implementations that are described throughout this document.

For example, FIG. 14 shows a general system diagram showing a simplified computing device 1400. Examples of such devices operable with the PiMovs System, include, but are not limited to, portable electronic devices, wearable computing devices, hand-held computing devices, laptop or mobile computers, communications devices such as cell phones, smartphones and PDA's, multiprocessor systems, microprocessor-based systems, set top boxes, programmable consumer electronics, network PCs, minicomputers, audio or video media players, handheld remote control devices, etc. Note also that the PiMovs System may be implemented with any touchscreen or touch-sensitive surface that is in communication with, or otherwise coupled to, a wide range of electronic devices or objects.

To allow a device to implement the PiMovs System, the computing device 1400 should have a sufficient computational capability and system memory to enable basic computational operations. In addition, the computing device 1400 may include one or more sensors 1405, including, but not limited to, accelerometers, cameras, capacitive sensors, proximity sensors, microphones, multi-spectral sensors, etc. Further, the computing device 1400 may also include optional system firmware 1425 (or other firmware or processor accessible memory or storage) for use in implementing various implementations of the PiMovs System.

As illustrated by FIG. 14, the computational capability of computing device 1400 is generally illustrated by one or more processing unit(s) 1410, and may also include one or more GPUs 1415, either or both in communication with system memory 1420. Note that that the processing unit(s) 1410 of the computing device 1400 may be a specialized microprocessor, such as a DSP, a VLIW, or other micro-controller, or can be a conventional CPU having one or more processing cores, including specialized GPU-based cores in a multi-core CPU.

In addition, the simplified computing device 1400 may also include other components, such as, for example, a communications interface 1430. The simplified computing device 1400 may also include one or more conventional computer input devices 1440 or combinations of such devices (e.g., touchscreens, touch-sensitive surfaces, pointing devices, keyboards, audio input devices, voice or speech-based input and control devices, video input devices, haptic input devices, devices for receiving wired or wireless data transmissions, etc.).

Similarly, various interactions with the simplified computing device 1400 and with any other component or feature of the PiMovs System, including input, output, control, feedback, and response to one or more users or other devices or systems associated with the PiMovs System, are enabled by a variety of Natural User Interface (NUI) scenarios. The NUI techniques and scenarios enabled by the PiMovs System include, but is not limited to, interface technology that allow one or more users user to interact with the PiMovs System in a “natural” manner, free from artificial constraints imposed by input devices such as mice, keyboards, remote controls, and the like.

Such NUI implementations are enabled by the use of various techniques, including, but not limited to, using NUI information derived from user speech or vocalizations captured via microphones or other sensors. Such NUI implementations are also enabled by the use of various techniques, including, but not limited to, information derived from user facial expressions, from the positions, motions, or orientations of user hands, fingers, wrist, arm, legs, body, head, eyes, etc., captured using imaging devices such as 2D or depth cameras (e.g., stereoscopic or time-of-flight camera systems, infrared camera systems, RGB camera systems, combinations of such devices, etc.). Further examples include, but are not limited to, NUI information derived from touch and stylus recognition, gesture recognition (both onscreen and adjacent to the screen or display surface), air or contact-based gestures, user touch on various surfaces, objects or other users, hover-based inputs or actions, etc. In addition, NUI implementations also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information is then used to initiate, terminate, or otherwise control or interact with one or more inputs, outputs, actions, or functional features of the PiMovs System.

However, it should also be understood that such NUI scenarios may be further augmented by combining the use of artificial constraints or additional signals with any combination of NUI inputs. Such artificial constraints or additional signals may be imposed or generated by input devices such as mice, keyboards, remote controls, or by a variety of remote or user worn devices such as accelerometers, Electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, etc. Any such information derived from these types of artificial constraints or additional signals may be combined with any one or more NUI inputs to initiate, terminate, or otherwise control or interact with one or more inputs, outputs, actions, or functional features of the PiMovs System.

The simplified computing device 1400 may also include other optional components, such as, for example, one or more conventional computer output devices 1450 (e.g., display device(s) 1455, audio output devices, video output devices, devices for transmitting wired or wireless data transmissions, etc.). Note that typical communications interfaces 1430, input devices 1440, output devices 1450, and storage devices 1460 for general-purpose computers are well known to those skilled in the art, and will not be described in detail herein.

The simplified computing device 1400 may also include a variety of computer readable media. Computer readable media can be any available media that can be accessed via storage devices 1460 and includes both volatile and nonvolatile media that is either removable 1470 and/or non-removable 1480, for storage of information such as computer-readable or computer-executable instructions, data structures, program modules, or other data.

By way of example, and not limitation, computer readable media may comprise computer storage media and communication media. Computer storage media refers to tangible computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

In contrast, storage or retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various implementations of the PiMovs System described herein, or portions thereof, may be stored, received, transmitted, or read from any desired combination of computer or machine readable media or storage devices and communication media in the form of computer executable instructions or other data structures.

Finally, the PiMovs System described herein may be further described in the general context of computer-executable instructions, such as program modules, being executed by a computing device. Generally, program modules include routines, programs, objects, components, data structures, etc., that perform particular tasks or implement particular abstract data types.

The implementations described herein may also be practiced in distributed computing environments where one or more tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Alternatively, or in addition, some or all of the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The foregoing description of the PiMovs System has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations of the PiMovs System. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. An interactive display comprising:
a contiguous display surface arranged to cover a perimeter of a 360-degree geometric framework;
one or more position sensing devices that track positions of one or more people within a predetermined radius around the geometric framework;
one or more computing devices that together generate a contiguous volumetric projection on the display surfaces, said contiguous volumetric projection comprising a seamless wrapping of the contiguous volumetric projection across any edges of any adjacent display surfaces comprising the contiguous display surface;
wherein the contiguous volumetric projection dynamically adapts to the tracked positions by dynamically adjusting the contiguous volumetric projection in response to the motion of one or more people as they move around the outside of the geometric framework.

2. The interactive display of claim 1 wherein the contiguous volumetric projection dynamically adapts to the tracked positions such that objects within the contiguous volumetric projection appear to occupy a consistent position in space within the geometric framework relative to the one or more people as they move around the outside of the geometric framework.

3. The interactive display of claim 1 wherein the contiguous display surface includes one or more rear projective display panels that are joined together along one or more adjacent edges to form corresponding sections of the geometric framework.

4. The interactive display of claim 3 wherein the display panels are joined to preserve optical properties of the display panels at the corresponding seams, thereby minimizing optical distortion of the volumetric projection at the corresponding seams.

5. The interactive display of claim 3 wherein one or more projectors are arranged within an interior of the geometric framework to project portions of the volumetric projection on corresponding portions of the rear projective display panels.

6. The interactive display of claim 1 wherein the contiguous volumetric projection is automatically selected from a set of one or more predefined volumetric projections in response to motions of one or more people within a predetermined zone around the geometric framework.

7. The interactive display of claim 1 wherein the contiguous volumetric projection dynamically adapts to one or more natural user interface (NUI) inputs from one or more people.

8. The interactive display of claim 7 wherein NUI inputs are accepted from one or more people within a predefined interaction zone at some minimum distance around the perimeter of the geometric framework.

9. The interactive display of claim 1 further comprising a communications interface that enables real-time interaction between multiple interactive displays, each of which includes a contiguous volumetric projection.

10. A system for displaying volumetric projections, comprising:
a general purpose computing device; and
a computer program comprising program modules executable by the computing device, wherein the computing device is directed by the program modules of the computer program to:
render a contiguous volumetric projection on one or more display surfaces forming a perimeter of a contiguous geometric framework, such that the contiguous volumetric projection provides a seamless wrapping of the contiguous volumetric projection across any adjacent edges of any adjacent display surfaces;
receive sensor data and track positions of one or more people within a predetermined radius around the geometric framework;
receive natural user interface (NUI) inputs from one or more of the people within the predetermined radius around the geometric framework; and
dynamically adapt the contiguous volumetric projection in response to the tracked positions and the NUI inputs.

11. The system of claim 10 wherein the contiguous volumetric projection dynamically adapts to the tracked positions such that objects within the contiguous volumetric projection appear to occupy a consistent position in space within the geometric framework relative to the one or more people as they move around the outside of the geometric framework.

12. The system of claim 10 wherein one or more of the display surfaces are rear projective display panels that are joined together along one or more adjacent edges.

13. The system of claim 12 wherein one or more projectors are arranged within an interior of the geometric framework to project contiguous portions of the volumetric projection on corresponding portions of the rear projective display panels.

14. The system of claim 10 wherein a communications interface enables real-time interaction between multiple instances of the system of claim 10, each of which includes a contiguous volumetric projection.

15. The system of claim 14 wherein the volumetric projection of two or more of the systems provides a dynamic volumetric rendering of one or more people communicating in real-time between those systems.

16. The system of claim 14 wherein the volumetric projection of two or more of the systems provides a dynamic volumetric rendering of a real-time interactive virtual ball game that allows one or more people to use NUI gestures to play ball between different of the systems.

17. The system of claim 10 wherein the volumetric projection provides a virtual avatar that reacts in real-time to NUI inputs of one or more people within the predetermined radius around the geometric framework.

18. A volumetric display device, comprising:
a plurality of adjacent display surfaces joined together to form a perimeter and a top of a contiguous geometric framework;
a computing device for rendering a contiguous volumetric projection as a seamless wrapping across each adjacent edge of each adjacent display surface;
using the computing device to receive sensor data for tracking positions of one or more people within a predetermined radius around the geometric framework; and
using the computing device to dynamically adapt the contiguous volumetric projection in response to the tracked positions such that objects within the contiguous volumetric projection appear to occupy a consistent position in space within the geometric framework relative to the one or more people as they move around the outside of the geometric framework.

19. The computer-readable medium of claim 18 wherein the computing device receives natural user interface (NUI) inputs from one or more of the people within the predetermined radius.

20. The computer-readable medium of claim 19 wherein the computing device dynamically adapts the contiguous volumetric projection in response to one or more of the NUI inputs.
